(19) United States
(12) Patent Application Publication
(10) Pub. No.: US 2025/0037023 A1
(43) Pub. Date: Jan. 30, 2025

(54) MACHINE LEARNING METHOD AND INFORMATION PROCESSING APPARATUS

(71) Applicants: Fujitsu Limited, Kawasaki-shi (JP); INDIAN INSTITUTE OF SCIENCE, Bengaluru (IN)

(72) Inventors: Sho TAKEMORI, Yokohama (JP); YUHEI UMEDA, Kawasaki (JP); Harsh Rangwani, Bengaluru (IN); Shrinivas Ramasubramanian, Bengaluru (IN); Kunal Samanta, Bengaluru (IN); Venkatesh Babu Radhakrishnan, Bengaluru (IN)

(73) Assignees: Fujitsu Limited, Kawasaki-shi (JP); INDIAN INSTITUTE OF SCIENCE, Bengaluru (IN)

(21) Appl. No.: 18/768,912

(22) Filed: Jul. 10, 2024

(30) Foreign Application Priority Data
Jul. 26, 2023 (IN) 202331050473

(51) Int. Cl. G06N 20/00

(52) U.S. Cl. CPC G06N 20/00

(57) ABSTRACT

A machine learning method includes estimating a degree of improvement of an evaluation metric related to a machine learning model, the improvement being to be obtained on a condition that the machine learning model is configured to be trained based on combination of training data in a training data set, selecting a pair of training data from the training data set based on the estimated degree, generating other training data based on the selected pair of training data, and training the machine learning model based on the other training data and the training data set, using a processor.

### CROSS-REFERENCE TO RELATED APPLICATION

This application is based upon and claims the benefit of priority of the prior Indian Patent Application No. 202331050473, filed on Jul. 26, 2023, the entire contents of which are incorporated herein by reference.

### FIELD

The embodiment discussed herein is related to a machine learning technology that performs training of a machine learning model by using training data.

### BACKGROUND

In recent years, a classifier (machine learning model) that has been trained by applying machine learning algorithm and using a training data set including a plurality of pieces of training data is used for abnormality detection, medical image diagnosis, or the like. In training of the classifier, it is known that generalization performance of a classifier is improved by performing data augmentation on the basis of Mixup that generates new training data obtained as a result of mixing combinations of the plurality of pieces of training data included in the training data set and by training the classifier using the augmented training data set.

For example, related arts are disclosed in Japanese Laid-open Patent Publication No. 2022-181204, Japanese Laid-open Patent Publication No. 2022-80213, Japanese Laid-open Patent Publication No. 2022-124989, U.S. Patent Application Publication No. 2021/0124993, and International Publication Pamphlet No. WO 2021/100818

### SUMMARY

According to an aspect of an embodiment, a machine learning method includes estimating a degree of improvement of an evaluation metric related to a machine learning model, the improvement being to be obtained on a condition that the machine learning model is configured to be trained based on combination of training data in a training data set, selecting a pair of training data from the training data set based on the estimated degree, generating other training data based on the selected pair of training data, and training the machine learning model based on the other training data and the training data set, using a processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of an information processing apparatus according to a present embodiment;

FIG. 2 is a flowchart illustrating a processing procedure of the information processing apparatus according to the present embodiment; and

FIG. 3 is a diagram illustrating one example of a hardware configuration of a computer that implements the same function as that of the information processing apparatus according to the present embodiment.

### DESCRIPTION OF EMBODIMENTS

In a case where training of a classifier is performed by using a training data set, it is difficult to appropriately evaluate the performance of the machine learning algorithm on the basis of only the accuracy of the classifier, so that, in some cases, a more complicated evaluation metric is used. The more complicated evaluation metric mentioned here is a constrained evaluation metric for preventing prediction of a classifier from being biased toward a specific class. However, as in the conventional technology described above, in a case where data augmentation is performed on the training data set by using Mixup, there is a problem in that it is difficult to optimize the more complicated evaluation metric, although it is useful for further improving the generalization performance of the classifier.

Preferred embodiments of an information processing apparatus, a machine learning method, and a machine learning program disclosed in the present invention will be described in detail below with reference to the accompanying drawings. Furthermore, the disclosed technology is not limited to the present embodiment described below. In addition, each of the embodiments can be used in any appropriate combination as long as processes do not conflict with each other.
Reference 1: Narasimhan, H., Menon, A. K.: Training over-parameterized models with non-decomposable objectives, NeurIPS 2021

First, a basic evaluation metric that is used in Reference 1 or the like and that is related to the prediction accuracy of a classifier will be described, and, in addition, an evaluation metric (for example, a constrained evaluation metric) that is more complicated than the basic evaluation metric will be described.

A classifier is defined as “F: X→(K)”. Here, “X” denotes a space of an input. (K)={1, . . . , K} is a set of labels.

A confusion matrix C(F) with K rows and K columns (hereinafter, referred to as a K×K confusion matrix C(F)) is defined as indicated in formula (1). In formula (1), “D” denotes a distribution of data. In formula (1), “1” is an indicator function. In the indicator function, in a case where “y=i, F(x)=j” is satisfied, a value of the indicator function is “1”, whereas, in a case where “y=i, F(x)=j” is not satisfied, a value of the indicator function is “0”. Furthermore, “E” in formula (1) corresponds to calculation for an expected value.

$${C}_{ij} ( F ) = {E}_{( x , y ) \sim D} ( 1 ( y = i , F ( x ) = j ) ) \qquad ( 1 )$$

A class distribution (class prior) is defined by formula (2) for each “i”.

$${π}_{i} = P ( y = i ) \qquad ( 2 )$$

First, one example of the basic evaluation metric will be described. An accuracy acc(F) of a classifier is defined by formula (3). For example, the accuracy corresponds to a proportion of the number of pieces of correctly answered data to all of the pieces of data that are input to a classifier.

$$acc ( F ) = {\sum }_{k = 1}^{K} {C}_{kk} ( F ) \qquad ( 3 )$$

A recall recᵢ(F) for each class of a classifier is defined by formula (4). The recall corresponds to a proportion of actually determined pieces of data to the number of pieces of data to be determined. For example, the recall indicates how many classifiers, among a plurality of pieces of data that are to be classified into a first class, are classified into the first class.

$${rec}_{i} ( F ) = {C}_{ii} ( F ) / P ( y = i ) \qquad ( 4 )$$

A precision precᵢ(F) for each class of a classifier is defined by formula (5). The precision corresponds to a proportion of actually correct answers to the number of determination counts of “data to be determined”. For example, the precision is a proportion of data to be actually classified into a first class to a plurality of pieces of data that have been classified into the first class by a classifier.

$${prec}_{i} ( F ) = {C}_{ii} ( F ) / {\sum }_{k = 1}^{K} {C}_{ki} ( F ) \qquad ( 5 )$$

A proportion predicted to be a class i by a classifier is defined as a coverage. A coverage covᵢ(F) is defined by formula (6).

$${cov}_{i} ( F ) = {\sum }_{k = 1}^{K} {C}_{ki} ( F ) \qquad ( 6 )$$

In the following, one example of a more complicated evaluation metric will be described. The worst recall is defined by formula (7). The worst recall is an evaluation metric that is useful for a data set with class imbalance.

$${min}_{1 \leq i \leq K} {rec}_{i} ( F ) \qquad ( 7 )$$

Similarly, in a case where a data set is a data set with class imbalance, there is a problem in that prediction of a classifier is biased toward a specific class. Therefore, in a classifier, optimization under a coverage constraint is important. Formula (8) is one example of an evaluation metric for performing optimization on an average recall under a coverage constraint. For example, formula (8) is an evaluation metric for maximizing a total value of recalls of classes 1 to K under a condition that a coverage is equal to or larger than “0.95×Πᵢ”.

$${max}_{F} \frac{1}{K} {\sum }_{i = 1}^{K} {rec}_{i} ( F ) subject to {cov}_{i} ( F ) \geq 0.95 {π}_{i} , ∀ i \qquad ( 8 )$$

In addition, in a classifier, an evaluation metric for performing optimization under a constraint related to a precision is also conceivable. The evaluation metric performing optimization under a constraint related to a precision is indicated by formula (9). For example, formula (9) is an evaluation metric for maximizing an accuracy acc(F) under a condition that a precision is equal to or larger than “τ (threshold)”.

$${max}_{F} acc ( F ) subject to {prec}_{i} ( F ) \geq τ , ∀ i \qquad ( 9 )$$

Reference 2: Rangwani et al, Cost-Sensitive Self-Training for Optimizing Non-Decomposable Metrics, NeurIPS 2022
Reference 3: Hongyi Zhang, Moustapha Cisse, Yann N Dauphin, and David Lopez-Paz. mixup: Beyond empirical risk minimization. In International Conference on Learning Representations, 2018.
Reference 4: Linjun Zhang et al, How Does Mixup Help With Robustness and Generalization?, ICLR 2021

In CSST (Reference 2), it is possible to perform learning of a classifier that optimizes a complicated evaluation metric by utilizing an unlabeled data set; however, the accuracy of the classifier is decreased.

In Mixup (Reference 3), data augmentation is performed on training data (x₁, y₁), . . . , and (x_{N}, y_{N}) for a classifier.

For example, in Mixup, a new sample indicated by formula (10) is generated with respect to an arbitrary number λ∈(0, 1), and two samples (xₙ, yₙ), and (xₘ, yₘ) in the training data.

$$( λ {x}_{n} + ( 1 - λ ) {x}_{m} , λ {y}_{n} + ( 1 - λ ) {y}_{m} ) \qquad ( 10 )$$

In Mixup, by repeating generation of these samples by L times, a new sample indicated by formula (11) is assumed to be used as training data for the classifier.

$$( {λ}_{1} {x}_{{n}_{1}} + ( 1 - {λ}_{1} ) {x}_{{m}_{1}} , {λ}_{1} {y}_{{n}_{1}} + ( 1 - {λ}_{1} ) {y}_{{m}_{1}} ) , … , \\ ( {λ}_{L} {x}_{{n}_{L}} + ( 1 - {λ}_{L} ) {x}_{{m}_{L}} , {λ}_{L} {y}_{{n}_{L}} + ( 1 - {λ}_{L} ) {y}_{{m}_{L}} ) \qquad ( 11 )$$

In Mixup described above, it has been known that the generalization performance of the classifier is improved (Reference 4). However, in Mixup described above, it is not possible to optimize the complicated evaluation metric related to the prediction accuracy of the classifier.

The information processing apparatus according to the present embodiment generates new training data, from a training data set that includes a plurality of pieces of training data, by combining these pieces of training data, and trains a parameter of a classifier (machine learning model) on the basis of the generated new training data and the plurality of pieces of training data.

Here, the information processing apparatus according to the present embodiment estimates a degree of improvement of a predetermined evaluation metric (for example, a complicated evaluation metric) related to a classifier obtained when the classifier has been trained on the basis of the generated training data. Then, the information processing apparatus according to the present embodiment selects a pair of the training data from the training data set on the basis of the estimated degree, and generates new training data on the basis of the selected pair of the training data. Consequently, in the information processing apparatus according to the present embodiment, it is possible to obtain, with high accuracy, a classifier in which the predetermined evaluation metric (for example, a complicated evaluation metric) related to the classifier has been improved while improving the generalization performance of the classifier.

In the following, one example of the information processing apparatus according to the present embodiment will be described. In the information processing apparatus according to the present embodiment, it is assumed that a last linear layer of a K class classifier used for deep learning.

In addition, it is assumed that a feature vector z is assigned to a sample x of the training data included in the training data set. It is also assumed that a classifier F outputs labels k (k=1, . . . , and K).

Specifically, a matrix W (Wₖ is a d-dimensional column vectors, k=1, . . . , and K) indicated by formula (12) below, and a feature vector zᵢ for each sample i are applied.

$$W = ( {W}_{1} , … , {W}_{K} ) \qquad ( 12 )$$

In addition, it is assumed that a probability that the classifier F predicts that a feature vector z associated with a sample is a label k is applied by formula (13) by using a softmax function.

$${softmax}_{k} ( {W}^{T} z ) \frac{exp ( {W}_{k}^{T} z )}{{\sum }_{j = 1}^{K} exp ( {W}_{k}^{T} z )} \qquad ( 13 )$$

Regarding k=1, . . . , and K, a distribution of the class label is indicated by formula (14) below.

$${π}_{k} = P ( y = k ) \qquad ( 14 )$$

The confusion matrix C (F) of the classifier F is defined similar to that defined in formula (1) (1≤i, j≤K).

In addition, regarding (Πᵢsoftmaxⱼ (Aᵢ))_{1≤j≤K}, a K-dimensional vector Aᵢ is determined as indicated in the i^{th} line of the confusion matrix C (F).

In addition, it is assumed that an evaluation metric M to be optimized is indicated by a function (differentiable function) of (A₁, . . . , and Aₖ) as indicated by formula (15) below. Here, the evaluation metric M is a basic evaluation metric related to the prediction accuracy of the classifier F, a complicated evaluation metric (for example, a constrained evaluation metric), or the like, and may be one or a plurality of indices that are set by a user as needed.

$$M = M ( {A}_{1} , … , {A}_{K} ) \qquad ( 15 )$$

In addition, assume that a and u are a pair of class label and defined as 1≤(a, u)≤K. Assume that zₐ denotes a feature vector of a sample (labeled training data) obtained in the case where a label is a. Assume that zᵤ denotes a feature vector of an unlabeled sample (unlabeled training data) obtained in the case where a pseudo-label is u.

Here, the pseudo-label is a label that has been output with respect to the unlabeled sample by the classifier F and that has been assigned to the unlabeled sample.

Mixup related to zₐ and zᵤ performed by the information processing apparatus according to the present embodiment is assumed to be formula (16) below. Here, λ denotes an appropriate distribution (for example, a uniform distribution).

$$z = λ {z}_{a} + ( 1 - λ ) {z}_{u} \qquad ( 16 )$$

The information processing apparatus according to the present embodiment trains the parameters (the matrix W) of the classifier F on the basis of the new training data that has been generated by Mixup and the training data (labeled training data) that is included in the training data set.

The information processing apparatus according to the present embodiment trains, regarding the new training data (z) generated by Mixup, the parameters (the matrix W) of the classifier such that a cross-entropy loss function l (z, a) is minimized by using a label of z as a because the reliability of the pseudo-label (u) is low. In addition, the cross-entropy loss function l (z,a) is indicated by formula (17) below.

$$l ( z , a ) = - log {softmax}_{a} ( {W}^{T} z ) \qquad ( 17 )$$

The information processing apparatus according to the present embodiment trains the parameters such that the sum of some samples of the cross-entropy loss function l (z, a) is minimized.

In the following, a description will be given of a case in which the information processing apparatus according to the present embodiment estimates the degree of improvement of the evaluation metric M related to the classifier F, and selects a pair of the class label (a, u) the basis of the estimated degree.

The information processing apparatus according to the present embodiment estimates, as follows, in order to determine a method of selecting (a, u), an increment of the evaluation metric M of the classifier F indicated at the time at which the classifier F has been trained by using the training data generated by Mixup.

It is assumed that the information processing apparatus according to the present embodiment uses, as one example, a gradient descent method in a process of training the parameters related to the classifier F. In a case where the gradient descent method is used, the matrix W is updated as a result of the parameters being trained, as indicated by formula (18) below.

$${W}_{t + 1} = {W}_{t} + Δ W , Δ W ( a , u ) = - η \frac{\partial l ( z , a )}{\partial W} \qquad ( 18 )$$

The information processing apparatus according to the present embodiment calculates a component (k, l) of ∂l(z,a)/∂W on the basis of formula (19) below. Here, δₐᵢ denotes the Kronecker delta.

$$- {z}_{k} ( {δ}_{ai} - {softmax}_{a} ( z ) ) \qquad ( 19 )$$

It is assumed that Aₖ has been updated to Aₖ+ΔAₖ as a result of an update of W.

The information processing apparatus according to the present embodiment estimates a change in the evaluation metric M, which has been obtained by updating W, as indicated by formula (20).

$$Δ M ( a , u ) = {\sum }_{k , l = 1}^{K} \frac{\partial M}{\partial {A}_{k , l}} {( Δ {A}_{k} )}_{l} \qquad ( 20 )$$

The information processing apparatus according to the present embodiment approximately estimates ΔAₖ using ΔWZₖ with respect to k=1, . . . , and K, where an average of the feature values of the samples (training data) belonging to the class k is denoted by Zₖ.

In this way, the information processing apparatus according to the present embodiment estimates the change in the evaluation metric M denoted by ΔM (a, u) for each (a, u) (1≤a, u≤K). Then, the information processing apparatus according to the present embodiment selects a pair of the class label (a, u) with a probability of formula (21) below.

$$exp ( Δ M ( α , u ) ) / {\sum }_{b , ν = 1}^{K} exp ( Δ M ( b , ν ) ) \qquad ( 21 )$$

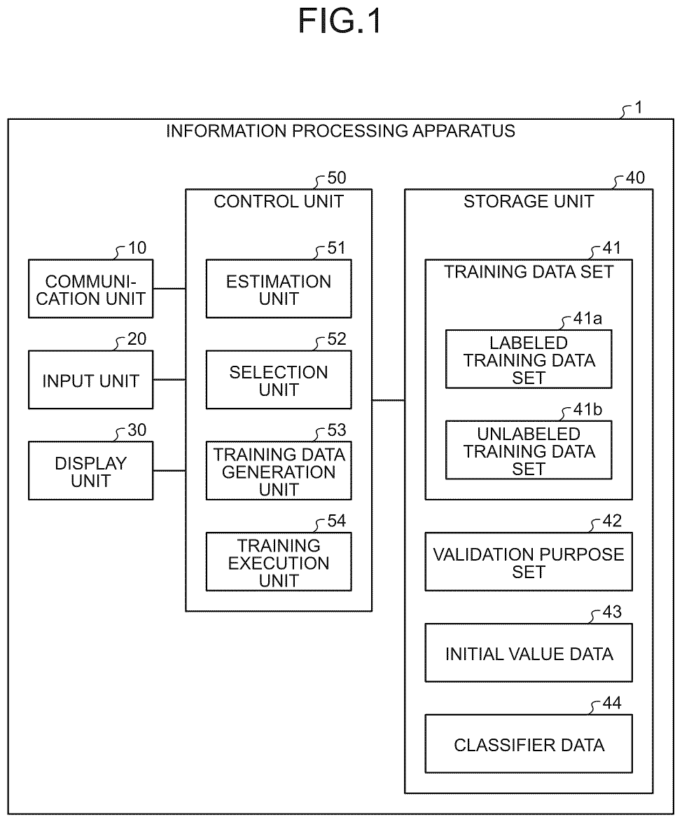

In the following, an example of a configuration of the information processing apparatus according to the present embodiment will be described. FIG. 1 is a functional block diagram illustrating a configuration of the information processing apparatus according to the present embodiment. As illustrated in FIG. 1, an information processing apparatus 1 includes a communication unit 10, an input unit 20, a display unit 30, a storage unit 40, and a control unit 50.

The communication unit 10 performs data communication with an external device or the like via a network. The communication unit 10 may receive a training data set 41, a validation purpose set 42, an initial value data 43, or the like, which will be described later, from an external device.

The input unit 20 receives an operation performed by a user. The user performs, for example, specifying the evaluation metric M by using the input unit 20.

The display unit 30 displays a processing result obtained by the control unit 50.

The storage unit 40 includes the training data set 41, the validation purpose set 42, the initial value data 43, and a classifier data 44. For example, the storage unit 40 is implemented by a memory or the like.

The training data set 41 includes a plurality of pieces of training data that are used to train the classifier F. Specifically, the training data set 41 includes a labeled training data set 41a that includes a plurality of pieces of training data to which a label (a) is assigned, and an unlabeled training data set 41b that includes pieces of unlabeled training data.

Here, the labeled training data is constituted of a pair of input data and a correct answer label (a). Furthermore, the unlabeled training data includes the input data and does not include the correct answer label. A pseudo-label assigned to the unlabeled training data is generated by the control unit 50 that will be described later.

The validation purpose set 42 includes a plurality of pieces of validation data. The validation data is constituted of a pair of input data and a correct answer label. The validation purpose set 42 is used when the confusion matrix C is estimated.

The initial value data 43 includes a repeat count (iteration count) T of training (learning) of the classifier F, an initial value of a weight of the last layer of the classifier F, a learning rate, the minimum value of λ, and the like.

The classifier data 44 is data that is included in the classifier F and that is to be trained. For example, the classifier F is a neural network (NN).

The control unit 50 includes an estimation unit 51, a selection unit 52, a training data generation unit 53, and a training execution unit 54. For example, the control unit 50 is implemented by a processor.

The estimation unit 51 is a processing unit that estimates an increment of the evaluation metric M of the classifier F, that is, a degree of improvement of the evaluation metric M of the classifier F, obtained when the classifier F is trained by using the training data that has been generated by Mixup.

The selection unit 52 selects a pair of the training data from the training data set 41 on the basis of the degree that has been estimated by the estimation unit 51. Specifically, the selection unit 52 selects a pair of the training data from each of the labeled training data set 41a and the unlabeled training data set 41b on the basis of the degree that has been estimated by the estimation unit 51, each with a class label (or a pseudo-label) (a) or (u). A pair of the training data has been selected appropriate class based on degree without labeled or unlabeled. For example, a pair of the training data has been uniformly at random selected from both data sets (the labeled training data set 41a and the unlabeled training data set 41b).

Here, the selection unit 52 generates a pseudo-label by inputting, to the classifier F, the unlabeled training data selected from the unlabeled training data set 41b. The selection unit 52 assigns the generated pseudo-label to the unlabeled training data selected from the unlabeled training data set 41b.

In addition, in the information processing apparatus 1 according to the present embodiment, it is assumed to perform semi-supervised learning on the basis of a combination of the labeled training data and the unlabeled training data. However, the learning performed on classifier F is not limited to the semi-supervised learning. For example, the information processing apparatus 1 may only perform the supervised learning. In this case, the selection unit 52 estimates a pair of training data from the labeled training data set 41a on the basis of the degree that has been estimated by the estimation unit 51.

The training data generation unit 53 is a processing unit that generates new training data on the basis of a pair of the training data selected by the selection unit 52. Specifically, the training data generation unit 53 generates new training data by performing Mixup on the pair of the training data in accordance with formula (16) indicated above.

The training execution unit 54 is a processing unit that trains the parameters (the matrix W) related to the classifier F on the basis of both of the new training data that has been generated by the training data generation unit 53 and the labeled training data that is included in the labeled training data set 41a. For example, the training execution unit 54 trains the parameter of the classifier F using the gradient descent method or the like such that, when certain training data is input to the classifier F, the label that is output by the classifier F corresponds to the label that is assigned to the training data.

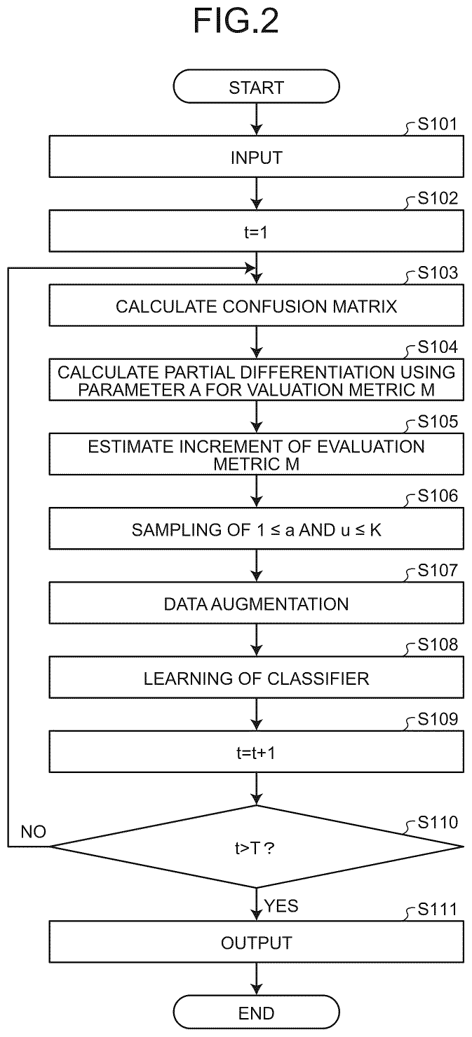

Here, the process of each of the estimation unit 51, the selection unit 52, the training data generation unit 53, and the training execution unit 54 performed in the information processing apparatus 1 according to the present embodiment will be described. FIG. 2 is a flowchart illustrating a processing procedure of the information processing apparatus according to the present embodiment.

As illustrated in FIG. 2, if a process has been started, the control unit 50 receives an input of data that is related to the process (Step S101).

Specifically, the control unit 50 receives an input of labeled training data D_{L} as indicated by formula (22) from the labeled training data set 41a. Here, in D_{L}, xᵢ (xᵢ∈X) denotes a sample, such as an image, that is assumed to be a vector. yᵢ denotes class label of xᵢ (an integer that satisfies 1≤yᵢ≤K).

$${D}_{L} = \{ ( {x}_{1} , {y}_{1} ) , … , ( {x}_{n} , {y}_{n} ) \} \qquad ( 22 )$$

In addition, the control unit 50 receives an input of unlabeled training data D_{U} as indicated by formula (23) from the unlabeled training data set 41b.

$${D}_{U} = \{ {u}_{1} , … , {u}_{m} \} ⊂ 𝒳 \qquad ( 23 )$$

In addition, the control unit 50 receives an input of labeled validation data Dᵥₐₗ, as indicated by formula (24), that is used to calculate a confusion matrix C[F] from the validation purpose set 42.

$${D}_{val} = \{ ( x , y ) : x ∈ 𝒳 , 1 \leq y \leq K \} \qquad ( 24 )$$

In addition, the control unit 50 receives an input of specifying the evaluation metric M via the input unit 20 or the like. Regarding the evaluation metric M, one or a plurality of the evaluation metric M are specified from the basic evaluation metric that is related to the prediction accuracy of the classifier F described above, or specified from the complicated evaluation metric (for example, a constrained evaluation metric).

In addition, the control unit 50 receives, from the initial value data 43, an input of an initial value W⁽¹⁾ of the weight of the last layer of the classifier F as indicated by formula (25). Here, W₁, . . . , and W_{K} denote d-dimensional column vectors.

$${W}^{( 1 )} = ( {W}_{1}^{( 1 )} , … , {W}_{K}^{( 1 )} ) \qquad ( 25 )$$

In addition, the control unit 50 receives, from the initial value data 43, an input of the repeat count T of the learning (training), a learning rate η (η>0), and a minimum value λₘᵢₙ of λ that is used for mixup.

In addition, an output of the results of the processes (Step S103 to Step S110) that are performed with respect to the above described inputs by the control unit 50 (Step S111) is the classifier data 44 that has been trained in the classifier F.

Specifically, the trained classifier F returns a value indicated by formula (26) below with respect to the sample x. Here W^{(T)} is the weight in T-th iteration updated by the iterative formula (18) with the initial value W⁽¹⁾.

$${argmax}_{1 \underline{<} i \leq K} {W}_{i}^{( T )} \cdot z \qquad ( 26 )$$

Here, the value indicated by formula (27) below is the weight (parameter) that has been updated during the training performed in the classifier data 44.

$$z = h ( x ) , {W}^{( T )} = ( {W}_{1}^{( T )} , … , {W}_{K}^{( T )} ) \qquad ( 27 )$$

After the process at Step S101, the control unit 50 sets to t=1 (Step S102). Then, the estimation unit 51 calculates a confusion matrix C^{(t)} on the basis of the validation data Dᵥₐₗ (Step S103). In addition, the confusion matrix C^{(t)} is defined by formula (28) below with respect to 1≤i, and j≤K.

$${C}_{ij}^{( t )} = \frac{1}{\vert {D}_{val} \vert} {\sum }_{( x , y ) ∈ {D}_{val}} 1 ( y = i , {F}^{( t )} ( x ) = j ) \qquad ( 28 )$$

Here, F^{(t)} (x) is defined by formula (29) below.

$${F}^{( t )} ( x ) = {argmax}_{1 \leq i \leq K} {W}_{i}^{( t )} \cdot h ( x ) \qquad ( 29 )$$

In addition, |Dᵥₐₗ| denotes the number of samples of Dᵥₐₗ. In addition 1 (y=i, F^{(t)} (x)=j) denotes a value of the indicator function that indicates 1 in a case where y=i and F^{(t)} (x)=j are satisfied, and that indicates 0 in a case where these conditions are not satisfied.

After that, the estimation unit 51 calculates a partial differentiation using a parameter A for the evaluation metric M (Step S104). After that, the estimation unit 51 estimates an increment of the evaluation metric M by using the calculated partial differentiation (Step S105).

Here, calculation of the partial differentiation performed by the estimation unit 51 will be described. The K×K confusion matrix C is represented by formula (30) below using a K×K matrix A.

$${C}_{i} = {π}_{i} softmax ( {A}_{i} ) \qquad ( 30 )$$

where, Cᵢ, and Aᵢ are the i^{th} row of the confusion matrix C and the matrix A, respectively. Formula (31) below is defined with respect to s∈R^{K}.

$$softmax ( s ) = {( \frac{exp ( {s}_{i} )}{{\sum }_{j = 1}^{K} exp ( {s}_{j} )} )}_{1 \leq i \leq K} \qquad ( 31 )$$

In addition, πᵢ denotes P (y=i), and is able to be calculated as a proportion corresponding to y=i to the samples (x, y) related to Dᵥₐₗ.

In addition, the function type of the evaluation metric M is already known, so that partial differentiation ∂M/∂Aₖₗ obtained based on the parameter A of the evaluation metric M (the function of the confusion matrix C) is able to be calculated.

The estimation unit 51 calculates formula (32) below by using a parameter A^{(t)} that is associated with C^{(t)}. In addition, formula (32) represents a value indicated at the time of A=A^{(t)} of the partial differentiation ∂M/∂Aₖₗ.

$$\frac{\partial M}{\partial {A}_{k l}} ( {A}^{( t )} ) \qquad ( 32 )$$

In the following, estimation of an increment of the evaluation metric M performed by the estimation unit 51 will be described. Assuming 1≤a, and u≤K are class labels. The average of the feature vectors with a label k with respect to each 1≤k≤K is indicated by formula (33) below.

$${Z}_{k} = {\sum }_{( x , y ) ∈ {D}_{val} , y = k} h ( x ) \qquad ( 33 )$$

In addition, assuming that l (z, i) is a cross-entropy loss function with respect to formula (34) below.

$$z ∈ {R}^{d} , 1 \leq i \leq K , W = ( {W}_{1} , … , {W}_{K} ) ∈ {R}^{d \times K} \qquad ( 34 )$$

The cross-entropy loss function of l (z, i) is indicated by formula (35) below.

$$- log {softmax}_{i} ( {W}^{T} z ) \qquad ( 35 )$$

In addition, ΔW^{(t)} (z, i) is defined as indicated by formula (36) below.

$$Δ {W}^{( t )} ( z , i ) = - η \frac{\partial l ( z , i )}{\partial W} ( {W}^{( t )} ) \qquad ( 36 )$$

Here, ∂l (z, i)/∂W (W^{(t)}) denotes a value obtained in a case where the gradient ∂l (z, i)/∂W is W=W^{(t)}. In addition, v^{(t)}ₗ(a. u) is assumed to be a l^{st} column of a vector with respect to 1≤l≤K in formula (37) below. Here, assuming that λ is a real number that has been sampled in accordance with a uniform distribution in a section (λₘᵢₙ, 1).

$$Δ {W}^{( t )} ( λ {Z}_{a} + ( 1 - λ ) {Z}_{u} , a ) \qquad ( 37 )$$

The estimation unit 51 calculates, by using the calculated partial differentiation, estimation ΔM (a, u) of an increment of the evaluation metric M on the basis of formula (38) below.

$$Δ M ( a , u ) = {\sum }_{1 \leq k , 1 \leq K} \frac{\partial M}{\partial {A}_{kl}} ( {A}^{( t )} ) {v}_{l}^{( t )} ( a , u ) \cdot {Z}_{k} \qquad ( 38 )$$

After the process at Step S105, the selection unit 52 performs sampling of 1≤a and u≤K on the basis of the estimation ΔM (a, u) of the increment of the evaluation metric M calculated by the estimation unit 51 (Step S106).

Specifically, the selection unit 52 performs sampling by using the probability indicated by formula (21) described above. As one example, the selection unit 52 selects a pair of the class label (a, u) with the probability described above and uniformly at random selects X₁ from among the samples (labeled training data has a class label (a)) indicated by formula (39).

$$\{ ( x , y ) ∈ {D}_{L} : y = a \} \qquad ( 39 )$$

In addition, the selection unit 52 selects a pair of the class label (a, u) with the probability described above and uniformly at random selects X₂ from among the samples (unlabeled training data has a pseudo-label (u)) indicated by formula (40).

$$\{ x ∈ {D}_{U} : {F}^{( t )} = u \} \qquad ( 40 )$$

After that, the training data generation unit 53 performs data augmentation of training data by generating new training data on the basis of the pair (X₁, X₂) of the training data selected by the selection unit 52 (Step S107). Specifically, the training data generation unit 53 performs mixup in accordance with formula (41) below.

$$mixup ( λ h ( {X}_{1} ) + ( 1 - λ ) h ( {X}_{2} ) , a ) \qquad ( 41 )$$

In addition, the new training data (z) obtained by mixup is indicated by formula (42) below.

$$z = λ h ( {X}_{1} ) + ( 1 - λ ) h ( {X}_{2} ) \qquad ( 42 )$$

After that, the training execution unit 54 performs learning (training) of the classifier F by using the training data that has been subjected to mixup (Step S108). Specifically, the training execution unit 54 updates W^{(t)} such that the cross-entropy loss function l (z, a) described above is minimized. In addition, in the control unit 50, it may be possible to perform the learning by using a batch learning technique in which the data augmentation is performed several times by using mixup. The training execution unit 54 defines the updated W as W^{(t+1)}.

After that, the control unit 50 increments t as t=t+1 (Step S109), and then determines whether or not t>T is satisfied (Step S110).

If t>T is not satisfied (No at Step S110), the control unit 50 returns the process to Step S103. If t>T is satisfied (Yes at Step S110), the control unit 50 performs output of the classifier data 44 in the classifier F described above (Step S111), and ends the process.

In the following, the effects of the information processing apparatus 1 according to the present embodiment will be described. The information processing apparatus 1 estimates the degree of improvement of a predetermined evaluation metric related to a machine learning model (classifier) obtained when the machine learning model is trained on the basis of training data that has been generated from a training data set 41 that includes a plurality of pieces of training data by combining the plurality of pieces of training data. The information processing apparatus 1 selects a pair of the training data from the training data set 41 on the basis of the estimated degree. The information processing apparatus 1 generates new training data on the basis of the selected pair of the training data. The information processing apparatus 1 trains the parameters of the machine learning model on the basis of the generated new training data and the plurality of pieces of training data.

Consequently, in the information processing apparatus 1, it is possible to obtain, with high accuracy, a machine learning model (classifier) in which the predetermined evaluation metric related to the machine learning model has been improved while improving the generalization performance of the machine learning model.

In addition, the information processing apparatus 1 uses, as the pair of the training data, first training data that has been selected from the labeled training data set 41a that includes the plurality of pieces of training data to each of which a label is assigned and second training data that is obtained by assigning a pseudo-label to the training data that has been selected from the unlabeled training data set 41b that includes the plurality of pieces of training data to each of which a label is not assigned.

As a result, in the information processing apparatus 1, it is possible to obtain the machine learning model by utilizing the unlabeled training data that is obtained from semi-supervised learning performed on the basis of a combination of the labeled training data and the unlabeled training data.

In addition, the information processing apparatus 1 trains, in the training of the machine learning model performed on the basis of the new training data, the parameters of the machine learning model on the basis of a value of the loss function obtained when the label assigned to the first training data corresponding to the original data of the new training data is used as a label of the new training data.

As a result, in the information processing apparatus 1, it is possible to obtain, with higher accuracy, a machine learning model on the basis of the label that is assigned to the training data in advance and that has higher reliability than the pseudo-label that has low reliability.

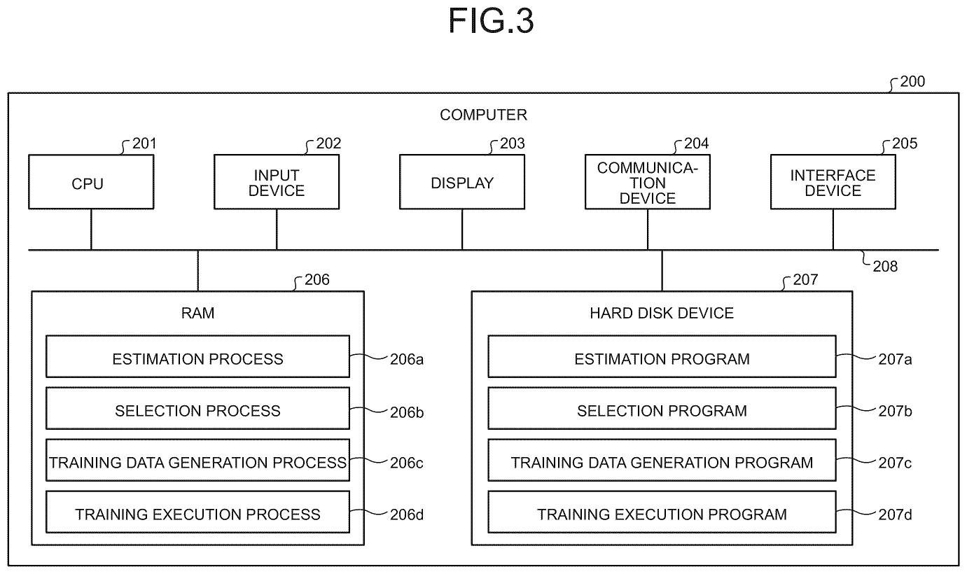

In the following, one example of a hardware configuration of a computer that implements the same function as that of the information processing apparatus 1 indicated in the above described embodiment will be described. FIG. 3 is a diagram illustrating one example of the hardware configuration of the computer that implements the same function as that of the information processing apparatus according to the present embodiment.

As illustrated in FIG. 3, a computer 200 includes a CPU 201 that executes various kinds of arithmetic processing, an input device 202 that receives an input of data from a user, and a display 203. In addition, the computer 200 includes a communication device 204 that receives and an interface device 205 that send and receive data to and from an external device or the like via a wired or wireless network. Furthermore, the computer 200 includes a RAM 206 that temporarily stores therein various kinds of information and a hard disk device 207. Moreover, each of the devices 201 to 207 is connected to a bus 208.

The hard disk device 207 includes an estimation program 207a, a selection program 207b, a training data generation program 207c, and a training execution program 207d. In addition, the CPU 201 reads each of the programs 207a to 207d and loads the programs into the RAM 206.

The estimation program 207a functions as an estimation process 206a. The selection program 207b functions as a selection process 206b. The training data generation program 207c functions as a training data generation process 206c. The training execution program 207d functions as a training execution process 206d.

The process of the estimation process 206a corresponds to the process performed by the estimation unit 51. The process of the selection process 206b corresponds to the process performed by the selection unit 52. The process of the training data generation process 206c corresponds to the process performed by the training data generation unit 53. The process of the training execution process 206d corresponds to the process performed by the training execution unit 54.

Furthermore, each of the programs 207a to 207d does not need to be stored in the hard disk device 207 from the beginning. For example, each of the programs is stored in a “portable physical medium”, such as a flexible disk (FD), a CD-ROM, a DVD disk, a magneto-optic disk, an IC card, that is to be inserted into the computer 200. Then, the computer 200 may read each of the programs 207a to 207d from the portable physical medium and execute the programs.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A machine learning method comprising:
estimating a degree of improvement of an evaluation metric related to a machine learning model, the improvement being to be obtained on a condition that the machine learning model is configured to be trained based on combination of training data in a training data set;
selecting a pair of training data from the training data set based on the estimated degree;
generating other training data based on the selected pair of training data; and
training the machine learning model based on the other training data and the training data set, using a processor.

2. The machine learning method according to claim 1, wherein the estimating includes estimating the degree based on an average of feature values of the training data belonging to a specific class.

3. The machine learning method according to claim 1, wherein the selecting includes:
selecting, based on the degree, a first label and a second label among a plurality of labels assigned to the training data set; and
selecting, from the training data set, first training data assigned with the first label and second training data assigned with the second label as a pair of the training data.

4. The machine learning method according to claim 3, wherein
the first label is a correct answer label assigned to the first training data, and
the second label is a pseudo label output by inputting the second training data to the machine learning model prior to the training.

5. The machine learning method according to claim 3, wherein the training includes training, in training of the machine learning model performed based on the new training data, the parameters of the machine learning model based on a value of a loss function obtained when the label assigned to the first training data corresponding to original data of the new training data is used as a label of the new training data.

6. An information processing apparatus comprising:
a processor configured to:
estimate a degree of improvement of an evaluation metric related to a machine learning model, the improvement being to be obtained on a condition that the machine learning model is trained based on other training data to be generated by combination of training data in a training data set;
select a pair of training data from the training data set based on the estimated degree;
generate the other training data based on the selected pair of training data; and
train the machine learning model based on the other training data and the training data set.

7. The information processing apparatus according to claim 6, wherein the processor is further configured to estimate the degree based on an average of feature values of the training data belonging to a specific class.

8. The information processing apparatus according to claim 6, wherein the processor is further configured to:
select, based on the degree, a first label and a second label among a plurality of labels assigned to the training data set; and
select, from the training data set, first training data assigned with the first label and second training data assigned with the second label as a pair of the training data.

9. The information processing apparatus according to claim 8, wherein
the first label is a correct answer label assigned to the first training data, and
the second label is a pseudo label output by inputting the second training data to the machine learning model prior to the training.

10. The information processing apparatus according to claim 8, wherein the processor is further configured to train, in training of the machine learning model performed based on the new training data, the parameters of the machine learning model based on a value of a loss function obtained when the label assigned to the first training data corresponding to original data of the new training data is used as a label of the new training data.
